(19) United States
(12) Patent Application Publication
(10) Pub. No.: US 2014/0170351 A1
(43) Pub. Date: Jun. 19, 2014

(54) HYDROLYSIS-STABLE POLYURETHANE FOR USE IN THE OFF-SHORE SECTOR

(71) Applicant: BASF SE, Ludwigshafen (DE)

(72) Inventors: Andre KAMM, Bohmte (DE); Julia Liese, Bremen (DE); Paul McCloud, Alfreton (GB)

(73) Assignee: BASF SE, Ludwigshafen (DE)

(21) Appl. No.: 14/102,661

(22) Filed: Dec. 11, 2013

Related U.S. Application Data
(60) Provisional application No. 61/736,586, filed on Dec. 13, 2012.

(51) Int. Cl. C09D 175/04; B32B 38/00; B32B 1/08

(52) U.S. Cl. CPC C09D 175/04; B32B 1/08; B32B 38/00
USPC 428/36.91; 524/591; 427/385.5; 156/242

(57) ABSTRACT

The present invention relates to a process for producing polyurethane-coated conduit elements, in which (a) aliphatic polyisocyanate is mixed with (b) compounds having at least two hydrogen atoms which are reactive toward isocyanate, (c) catalyst and (d) optionally other auxiliaries and/or additives, to form a first reaction mixture, the reaction mixture is applied directly or indirectly to a pipe and allowed to react to form a polyurethane layer, wherein the compounds having at least two hydrogen atoms which are reactive toward isocyanate comprise a compound based on an alkoxylation product of an aromatic starter molecule. The present invention further relates to conduit elements which can be obtained by such a process.

The present invention relates to a process for producing polyurethane-coated conduit elements, in which (a) aliphatic polyisocyanate is mixed with (b) compounds having at least two hydrogen atoms which are reactive toward isocyanate, (c) catalyst and (d) optionally other auxiliaries and/or additives, to form a first reaction mixture, the reaction mixture is applied directly or indirectly to a pipe and allowed to react to form a polyurethane layer, wherein the compounds having at least two hydrogen atoms which are reactive toward isocyanate comprise a compound based on an alkoxylation product of an aromatic starter molecule. The present invention further relates to conduit elements which can be obtained by such a process.

In the recovery of petroleum from the sea, petroleum reserves are increasingly being recovered from great depths. The petroleum from such reservoirs has a temperature of greater than 100° C. (up to 150° C.). This oil is pumped via pipelines from the offshore reservoir to the land. In order to reduce the heat loss from the oil and thereby avoid precipitation of waxes from the oil in the case of a cessation of pumping, the pipeline is provided with a coating, for example polyurethane.

Thus, WO 2005/056629 describes a process for producing a polyurethane filled with hollow glass spheres in order to reduce the heat loss from an oil pipeline. In WO 2005/056629, aromatic isocyanates are preferably used.

Due to the ever deeper wells and the resulting higher temperature of the oil, the pipeline coatings are subjected to ever higher thermal stress. This thermal stress under water requires improved hydrolysis stability of the coating.

WO 2007/042411, WO 99/03922 and WO 2010/003788 disclose coatings based on polyisocyanurates. These have the advantage of better temperature stability. However, the hydrolysis stability at high temperatures is only improved to a limited extent compared to normal polyurethanes. Furthermore, the system have the disadvantage of reacting particularly quickly, so that filling of large volumes can be achieved only with difficulty. Likewise, polyisocyanurates are relatively brittle because of the high crosslinking by the isocyanurate ring.

It is known from P. A. Ykaman, Recent developments in aliphatic thermoplastic PU, Thermoplastische Elastomere III, Rapra Technology Limited, 1991, that polyether polyurethane based on aliphatic isocyanates has improved hydrolysis stability compared to polyurethane based on aromatic isocyanates. However, a disadvantage of the aliphatic isocyanates is their high volatility. Due to the toxicity on inhalation, processing of aliphatic isocyanates requires complicated safety precautions. In addition, aliphatic isocyanates usually react quite sluggishly.

Another possible way of circumventing the problem of toxicity of aliphatic isocyanates such as HDI is the use of modified aliphatic isocyanates (functionality >2), e.g. isocyanurates. Such modified, aliphatic isocyanates having a functionality of greater than 2 are marketed, for example, under the trade name Basonat®. These polyfunctional aliphatic isocyanates display good reactivity due to the high proportion of isocyanate, but the mechanical properties of these polyurethanes are unsatisfactory.

It was an object of the present invention to develop a pipeline having a pipeline coating which has improved hydrolysis stability at high temperatures and nevertheless satisfies the high mechanical demands in the oil and gas industry.

This object is achieved by a polyurethane-coated conduit element which can be produced by a process in which (a) aliphatic polyisocyanate is mixed with (b) compounds having at least two hydrogen atoms which are reactive toward isocyanate, (c) catalyst and (d) optionally other auxiliaries and/or additives, to form a first reaction mixture, the reaction mixture is applied to a conduit element and allowed to react to form a polyurethane layer, wherein the compounds having at least two hydrogen atoms which are reactive toward isocyanate comprise a compound based on an alkoxylation product of an aromatic starter molecule.

Furthermore, the object of the invention is achieved by a polyurethane-coated conduit element which can be produced by a process in which (a) aliphatic polyisocyanate is mixed with (b) compounds having at least two hydrogen atoms which are reactive toward isocyanate, (c) catalyst and (d) optionally other auxiliaries and/or additives to form a first reaction mixture, the reaction mixture is introduced into a mold and cured to form a molding, the molding is removed from the mold and applied to a conduit element, wherein the compounds having at least two hydrogen atoms which are reactive toward isocyanate comprise a compound based on an alkoxylation product of an aromatic starter molecule.

For the purposes of the present invention, polyurethane-coated conduit elements are not only classical coated pipes but also polyurethane-coated weld regions of pipelines, known as “field joints”, and polyurethane-coated objects which are joined to pipelines, e.g. muffs, well connections, eruption crosses, pipe collectors, pumps and buoys. Conduit elements also comprise polyurethane-coated cables, preferably off-shore cables. Furthermore, pipes having sheathing for reinforcement, e.g. bend stiffeners or bend restrictors are also encompassed by the expression polyurethane-coated conduit element, where the bend stiffeners and the bend restrictors correspond to the polyurethane coating. The polyurethane-coated conduit element according to the invention is preferably a conduit element of an off-shore pipeline or an off-shore cable. Here, “off-shore” means that these objects come into contact with sea water during normal use. The polyurethane-coated conduit element according to the invention is particularly preferably a polyurethane-coated pipe of an off-shore pipeline, a field joint of an off-shore pipeline or an eruption cross (also referred to as X-Mas tree) of an off-shore pipeline, in particular an off-shore pipeline for conveying crude oil.

Coating of the parts can be carried out directly or indirectly; in the case of indirect coating, the polyurethane is produced separately and then applied by means of, for example, screws to the element to be coated. Preference is given to polyurethane being poured or sprayed directly onto the surface of the material to be coated. In general, the surfaces to be coated consist of metals such as steel, iron, copper or aluminum or of plastics such as polypropylene or epoxy resins. To improve adhesion, conventional bonding agents such as internal bonding agents which are added to the polyurethane components, external bonding agents which are applied directly to the surface to be coated and/or physical bonding agents can optionally also be used. The surface to be coated can also be pretreated, for example by application of a flame or plasma treatment.

For the purposes of the present invention, aliphatic isocyanates (a) comprise the aliphatic and cycloaliphatic bifunctional or polyfunctional isocyanates known from the prior art (constituent a-1) and any mixtures thereof. Examples are tetramethylene diisocyanate, hexamethylene diisocyanate (HDI), isophorone diisocyanate (IPDI), 4,4′-diisocyanatodicyclohexylmethane (H12MDI) or mixtures of the isocyanates mentioned. Apart from the aliphatic isocyanates, it is also possible to use aromatic isocyanates such as tolylene 2,4- or 2,6-diisocyanate (TDI), diphenylmethane 4,4′-diisocyanate, diphenylmethane 2,4′-diisocyanate, the mixtures of monomeric diphenylmethane diisocyanates and homologs of diphenylmethane diisocyanate having more than two rings (polymeric MDI). In particular, less than 50% by weight, particularly preferably less than 20% by weight, more preferably less than 10% by weight, of aromatic isocyanates, in each case based on the total weight of all isocyanates used, and especially no aromatic isocyanates are used in the process of the invention.

The isocyanates mentioned can be used either directly or in the form of reaction products with themselves, e.g. isocyanurates, allophanates, biurets, isocyanurates, uretdiones or carbodiimides, and also in the form of isocyanate-terminated prepolymers. The aliphatic isocyanate preferably comprises less than 15% by weight, particularly preferably less than 7.5% by weight and in particular less than 1% by weight, based on the total weight of the aliphatic isocyanate, of monomeric aliphatic isocyanate. The remaining amount of aliphatic isocyanate is present as modified aliphatic isocyanate. The aliphatic isocyanates (a) particularly preferably comprise isocyanurates, in particular the isocyanurate of hexamethylene diisocyanate.

As compounds (b) having at least two hydrogen atoms which are reactive toward isocyanate, it is possible to use all compounds which have hydrogen atoms which are reactive toward isocyanates and are known in polyurethane chemistry. These comprise polymeric compounds having at least two hydrogen atoms which are reactive toward isocyanate and also chain extenders and crosslinkers. Polymeric compounds having at least two hydrogen atoms which are reactive toward isocyanates have a molecular weight of at least 450 g/mol. These have, for example, a functionality of from 2 to 8 and a molecular weight of from 450 to 12 000. It is thus possible to use, for example, polyether polyamines and/or polyols selected from the group consisting of polyether polyols, polyester polyols and mixtures thereof.

As chain extenders and/or crosslinkers, it is possible to use substances having a molecular weight of less than 450 g/mol, particularly preferably from 60 to 400 g/mol, with chain extenders having two hydrogen atoms which are reactive toward isocyanates and crosslinkers having 3 or more hydrogen atoms which are reactive toward isocyanate. These can be used individually or preferably in the form of mixtures. Preference is given to using diols and/or triols having molecular weights of less than 450, particularly preferably from 60 to 400 and in particular form 60 to 350. Possibilities are, for example, aliphatic, cycloaliphatic and/or araliphatic or aromatic diols having from 2 to 14, preferably from 2 to 10, carbon atoms, e.g. ethylene glycol, 1,3-propanediol, 1,4-butanediol, 1,6-hexanediol, 1,10-decanediol and bis(2-hydroxyethyl)hydroquinone, 1,2-, 1,3-, 1,4-dihydroxycyclohexane, diethylene glycol, dipropylene glycol, tripropylene glycol, triols such as 1,2,4-, 1,3,5-trihydroxy-cyclohexane, glycerol and trimethylolpropane, and low molecular weight hydroxyl-comprising polyalkylene oxides based on ethylene oxide and/or 1,2-propylene oxide and the abovementioned diols and/or triols as starter molecules.

Compounds (b) having at least two hydrogen atoms which are reactive toward isocyanate comprise at least one compound based on an alkoxylation product of an aromatic starter molecule (b1). Depending on the chain length, this can come under the definition of polymeric compounds having at least two hydrogen atoms which are reactive toward isocyanates or chain extenders and possibly crosslinkers. Suitable aromatic starter molecules here are, for example, phenylenediamine, 2,3-, 2,4- and 2,6-tolylenediamine (TDA), 4,4′-, 2,4′- and 2,2′-diaminodiphenylmethane (MDA), polymeric MDA, and bisphenols.

The aromatic starter molecule preferably has at least two benzene rings and is particularly preferably a bisphenol or a derivative of a bisphenol. For the purposes of the invention, derivatives are compounds in which hydrogen atoms on aromatic or aliphatic carbon atoms have been replaced by carbon atoms or hydrocarbon radicals such as alkyl or aryl radicals. These hydrocarbon radicals can be unsubstituted or substituted, for example by halogen atoms, oxygen, sulfur or phosphorus. These can be used individually or in the form of mixtures.

Bisphenols comprise bisphenol A, bisphenol AF, bisphenol AP, bisphenol BP, bisphenol C, bisphenol E, bisphenol F, bisphenol FL, bisphenol G, bisphenol M, bisphenol P, bisphenol PH, bisphenol S, bisphenol TMC and bisphenol Z. Particular preference is given to using bisphenol A and/or bisphenol S and in particular bisphenol A as aromatic starter molecule.

The compounds based on an alkoxylation product of an aromatic starter molecule are obtained by alkoxylation of the starter molecule by means of alkylene oxides. For example, they can be obtained by an ionic polymerization of the starter molecules with alkylene oxides using alkali metal hydroxides such as sodium or potassium hydroxide or alkali metal alkoxides such as sodium methoxide, sodium or potassium ethoxide or potassium isopropoxide as catalysts. Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures. Preference is given to using ethylene oxide or propylene oxide, in particular ethylene oxide, as alkylene oxide.

The alkoxylation products of an aromatic starter molecule can be used without modification. One or both, or, if present, also further OH groups of the alkoxylation product of an aromatic starter molecule can optionally be converted into amino group(s) in order to increase the reactivity. Compounds based on an alkoxylation product of an aromatic starter molecule therefore comprise both the directly obtainable alkylation products and the reaction products of these alkylation products in order to functionalize the OH groups, for example the reaction products to form amine.

The compounds according to the invention based on an alkoxylation product of an aromatic starter molecule preferably have a hydroxyl number of from 100 to 400 mg KOH/g, particularly preferably from 150 to 350 mg KOH/g and in particular from 200 to 300 mg KOH/g. Alkoxylation products of bisphenol A as starter with ethylene oxide are marketed under the trade name Pluriol® BP 30, 40, 60 or 100 by BASF.

Apart from the compounds based on an alkoxylation product of an aromatic starter molecule, the compounds (b) having at least two hydrogen atoms which are reactive toward isocyanate preferably comprise further polyols. The polyols which are preferably used are polyetherols, polycarbonate polyols and/or polyesterols having molecular weights in the range from 450 to 12 000, preferably from 500 to 6000, in particular from 500 to <3000, and preferably an average functionality of from 2 to 6, preferably from 2 to 4. Preference is given to using exclusively polyetherols and polycarbonate polyols as polyols.

The polyetherols which can be used according to the invention are prepared by known methods. For example, they can be prepared by anionic polymerization using alkali metal hydroxides such as sodium or potassium hydroxide or alkali metal alkoxides such as sodium methoxide, sodium or potassium ethoxide or potassium isopropoxide as catalysts with addition of at least one starter molecule having from 2 to 8, preferably from 2 to 6, reactive hydrogen atoms, or by cationic polymerization using Lewis acids such as antimony pentachloride, boron fluoride etherate, etc., or bleaching earth as catalysts. Polyether polyols can likewise be prepared from one or more alkylene oxides having from 2 to 4 carbon atoms in the alkylene radical by double metal cyanide catalysis. Tertiary amines, for example triethylamine, tributylamine, trimethylamine, dimethylethanolamine, imidazole or dimethylcyclohexylamine, can also be used as catalyst. For specific applications, monofunctional starters can also be incorporated into the polyether structure.

Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures.

Possible starter molecules are, for example: water, aliphatic and aromatic, optionally N-monoalky-, N,N- and N,N′-dialkyl-substituted diamines having from 1 to 4 carbon atoms in the alkyl radical, e.g. optionally monoalkyl- and dialkyl-substituted ethylenediamine, diethylentriamine, triethylenetetramine, 1,3-propylenediamine, 1,3- or 1,4-butylenediamine, 1,2-, 1,3-, 1,4-, 1,5- and 1,6-hexamethylenediamine, phenylenediamine, 2,3-, 2,4- and 2,6-tolylenediamine (TDA) and 4,4′-, 2,4′- and 2,2′-iaminodiphenylmethane (MDA) and polymeric MDA. Further possible starter molecules are: alkanolamines, such as ethanolamine, N-methylethanolamine and N-ethylethanolamine, dialkanolamines such as diethanolamine, N-methyldiethanolamine and N-ethyldiethanolamine, trialkanolamines such as triethanolamine, and ammonia. Preference is given to using polyhydric alcohols such as ethanediol, 1,2- and 2,3-propanediol, diethylene glycol, dipropylene glycol, 1,4-butanediol, 1,6-hexanediol, glycerol, trimethylolpropane; pentaerythritol, sorbitol and sucrose, and mixtures thereof. The polyether polyols can be used individually or in the form of mixtures.

The compounds (b) having at least two hydrogen atoms which are reactive toward isocyanates preferably comprise polyether polyols based on a bifunctional starter molecule (b2) and polyether polyols based on a trifunctional starter molecule (b3) in addition to compounds based on an alkoxylation product of an aromatic starter molecule (b1).

As bifunctional starter molecules for preparing the constituent (b2), it is possible to use, for example, ethanediol, 1,2- and 1,3-propanediol, diethylene glycol, dipropylene glycol, 1,4-butanediol or 1,6-hexanediol or mixtures thereof. Preference is given to using diethylene glycol or dipropylene glycol.

In general, the alkoxylation to form the constituent (b2) is carried out in such a way that the constituent (b2) has a number average molecular weight of from 500 g/mol to 3500 g/mol, preferably from 600 to 2500 g/mol, particularly preferably from 800 to 1500 g/mol.

As trifunctional starter molecules for preparing the constituent (b3), preference is given to using glycerol, trimethylolpropane or mixtures thereof.

In general, the alkoxylation to form the constituent (b3) is carried out in such a way that the constituent (b2) has a number average molecular weight of from 500 g/mol to 8000 g/mol, preferably from 1000 to 6000 g/mol.

In a preferred embodiment, the polyol constituent (b3) comprises the constituents (b3-1) and (b3-2), where these constituents are each a polyether polyol based on a trifunctional starter molecule but have different molecular weights.

The constituent (b3-1) comprises a polyether polyol based on a trifunctional starter molecule and having a number average molecular weight of from 500 g/mol to 3500 g/mol, preferably from 1000 to 3200 g/mol, particularly preferably from 1500 to 3000 g/mol, in particular from 1800 to 2900 g/mol.

The constituent (b3-2) is usually a polyether polyol based on a trifunctional starter molecule and having a number average molecular weight of from >3500 g/mol to 8000 g/mol, preferably from 3700 to 7000 g/mol, particularly preferably from 4000 g/mol to 6000 g/mol.

In a further embodiment, the polymeric compounds having at least two hydrogen atoms which are reactive toward isocyanate comprise a polyether polyol based on a tetrafunctional or higher-functional starter molecule as additional constituent b4). Preference is given to using tetrafunctional to hexafunctional starter molecules. Examples of suitable starter molecules are pentaerythritol, sorbitol and sucrose.

The polycarbonate polyols which can be used according to the invention are prepared by known processes, for example as described in JP1998000267980 and U.S. 62/655,524. They are obtained, for example, by means of an ester exchange reaction with an aliphatic diol and dimethyl carbonate. For the purposes of the invention, polycarbonate polyols preferably have number average molecular weights of from 500 to 2000 g/mol, particularly preferably from 500 to 1000 g/mol, and functionalities of preferably from 2 to 6 and particularly preferably from 2 to 3. As polycarbonate polyols, it is possible to use, for example, commercially available polycarbonate polyols such as Eternacoll® UH 100, UH 50 or PH 200 from UBE Chemicals.

The components b1), b2), b3) and optionally b4) are preferably used in such an amount that the viscosity of the compounds having at least two hydrogen atoms which are reactive toward isocyanate at 25° C., measured in accordance with DIN 53019, is less than 1000 mPas, preferably less than 500 mPas at 25° C. and particularly preferably from 200 to 400 mPas.

The compounds (b) having at least two hydrogen atoms which are reactive toward isocyanate preferably do not comprise any further chain extenders in addition to the compounds based on an alkoxylation product of an aromatic starter molecule.

As catalysts (c) for producing the polyurethane moldings, preference is given to using compounds which strongly accelerate the reaction of the hydroxide-comprising compounds of the component (b) with the organic, optionally modified polyisocyanates (a). Mention may be made by way of example of amidines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethyl-butanediamine, N,N,N′,N′-tetramethyl-hexanediamine, pentamethyl-diethylenetriamine, bis(dimethylaminoethyl) ether, bis(dimethylaminopropyl)urea, dimethylpiperazine, 1,2-dimethylimidazole, 1-azabicyclo[3.3.0]octane and preferably 1,4-diazabicyclo[2.2.2]octane and alkanolamine compounds such as triethanolamine, triisopropanolamine, N-methyldiethanolamine and N-ethyldiethanolamine and dimethylethanolamine. Further possibilities are organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or mixtures thereof. The organic metal compounds can be used either alone or preferably in combination with strongly basic amines. If the component (b) is an ester, preference is given to using exclusively amine catalysts.

Preference is given to using from 0.001 to 5% by weight, in particular from 0.05 to 2% by weight, of catalyst or catalyst combination, based on the weight of the component (b).

Auxiliaries and additives (d) can optionally be added to the mixture of the components a) to c). Mention may here be made by way of example of surface-active substances, dyes, pigments, hydrolysis inhibitors, oxidation inhibitors, UV stabilizers, latent heat stores and hollow microspheres.

For the purposes of the present invention, the term hollow microspheres refers to organic and mineral hollow spheres. As organic hollow spheres, it is possible to use, for example, hollow polymer spheres, e.g. composed of polyethylene, polypropylene, polyurethane, polystyrene or a mixture thereof. The mineral hollow spheres can comprise, for example, clay, aluminum silicate, glass or mixtures thereof.

The hollow spheres can have a vacuum or partial vacuum in their interior or the interior can be filled with air, inner gases, for example nitrogen, helium or argon, or reactive gases, for example oxygen.

The organic or mineral hollow spheres usually have a diameter of from 1 to 1000 μm, preferably from 5 to 200 μm. The organic or mineral hollow spheres usually have a bulk density of from 0.1 to 0.4 g/cm³. They generally have a thermal conductivity of from 0.03 to 0.12 W/mK.

Preference is given to using hollow glass microspheres as hollow microspheres. In a particularly preferred embodiment, the hollow glass microspheres have a hydrostatic compressive strength of at least 20 bar. For example, 3M-Scotchlite® Glass Bubbles can be used as hollow glass microspheres.

As latent heat stores, it is possible to use encapsulated and nonencapsulated, lipophilic substances having a solid/liquid transition above 20° C., mostly waxes. These can be encapsulated in a polymer. During ongoing crude oil pumping, the latent heat stores take up heat from the warm crude oil and melt. In the case of a brief production stop, the insulating layer cools slowly from the outside, resulting in the lipophilic filling of the latent heat store also cooling, solidifying and thus releasing the absorbed heat to the crude oil again. Similar solutions are described in DE 10256550, WO 2004003424, U.S. Pat. No. 6,000,438, WO 2002016733 or CN 101545565.

Thixotropes such as Laromin® C 260 (dimethylmethylenebiscyclohexylamine) can also be comprised as auxiliaries and additives (d). In general, the amount of these thixotropes used is in the range from 0.1 to 3 parts by weight per 100 parts by weight of the component (b).

Furthermore, it is possible to add blowing agents known from the prior art as auxiliaries and additives (d). However, preference is given to not using any blowing agents, in particular not adding any water. Thus, the components a) and b) particularly preferably do not comprise any blowing agent apart from residual water which is comprised in industrially produced polyols.

Furthermore, particular preference is given to the residual water content being reduced by the addition of water scavengers. Suitable water scavengers are, for example, zeolites. The water scavengers are used in an amount of, for example, from 0.1 to 10% by weight, based on the total weight of the polyol component b).

If, as described above, no blowing agents are used, compact polyurethanes rather than polyurethane foams are obtained as product according to the invention.

To produce the polyurethane reaction mixture according to the invention, the organic polyisocyanates a) and the components comprising compounds having isocyanate-reactive hydrogen atoms are reacted in such amounts that the equivalence ratio of NCO groups of the isocyanates to the sum of the reactive hydrogen atoms is from 1:0.5 to 1:3.50 (corresponding to an isocyanate index of from 50 to 350), preferably from 1:0.85 to 1:1.30 and particularly preferably from 1:0.9 to 1:1.15.

The starting components are usually mixed at a temperature of from 0° C. to 100° C., preferably from 15° C. to 60° C. and reacted. Mixing can be carried out in conventional PUR processing machines. In a preferred embodiment, mixing is carried out by means of low-pressure machines or high-pressure machines. Here, the parts to be coated can either be produced by casting in a mold or by means of a rotational process. However, preference is given to casting in a mold.

Here, the reaction mixture of the components (a), (b), (c), (d), (e) and optionally (f) are poured into a mold which comprises the element to be coated, for example the pipe. After curing of the polyurethane, the mold is removed. The material can be used immediately. In a particular embodiment of the invention, the coated part is subjected to a further heat treatment.

In the rotational casting process, the reaction mixture is applied by pouring onto the rotating element, for example the pipeline pipe. Here, the reaction mixture is obtained by means of conventional mixing devices, e.g. a low-pressure mixing head. In a particular embodiment, discharge is effected via a slit die. The advance of the mixing head or of the pipe is generally set so that the desired thickness of the polyurethane layer is achieved at a constant output. For this purpose, the reaction mixture can preferably comprise thixotropes, which prevents dripping of the reaction mixture from the rotating element.

As an alternative, coating can be carried out indirectly. For this purpose, the reaction mixture of the components (a), (b), (c), (d), (e) and optionally (f) is poured into a mold and subsequently removed from the mold. The molding produced in this way is then applied to the pipe element to be coated, for example by screwing or adhesive bonding.

The thickness of the polyurethane layer is preferably from 5 to 200 mm, particularly preferably from 10 to 150 mm and in particular from 20 to 100 mm. One or more further layers, e.g. an insulating layer and/or a covering layer of a thermoplastic, can optionally be applied to the polyurethane layer. Preference is given to no further layers being applied to the polyurethane layer.

The polyurethane coating according to the invention has excellent mechanical properties such as elongation at break and tensile strength and also excellent hydrolysis stability. Furthermore, aliphatic isocyanate can be replaced, giving an inexpensive product having improved mechanical properties.

Such a conduit element, for example a pipe, can be an uncoated conduit element made of steel, but it is also possible to use conduit elements which already have one or more layers of coating. For the purposes of the present invention, the conduit element is preferably coated directly with the polyurethane reaction mixture according to the invention. As an alternative, the polyurethane reaction mixture according to the invention can also be applied to, for example, a conduit element coated with powder sprayed fusion-bonded epoxy or with polypropylene. The conduit element can optionally already have been coated with a first polyurethane layer which comprises, for example, latent heat stores. The polyurethane reaction mixture is subsequently cured to form a polyurethane layer, optionally with heat treatment, for example by irradiation or in an oven.

The invention is illustrated by the following examples.

### Starting Materials

Polyol 1: polycarbonate diol UH 100 from UBE having an OH number of 107 mg KOH/g Polyol 2: polycarbonate diol Oxymer M 112 from Perstop having an OH number of 112 mg KOH/g
Defoam: antifoam
KV 1: 1,4-butanediol
KV 2: bisphenol A ethoxylate from BASF SE (Pluriol® BP 40 E) having an OH number of 278 mg KOH/g
Z 1: zeolite paste in castor oil (50% strength)
Z 2: zeolite powder
Kat 1: Fomrez UL 28
ISO 1: aliphatic isocyanate Basonat HI 100 from BASF having an NCO content of 22%

Here, MR is the mixing ratio of the polyol component composed of polyol, KV, Defoam, Z and Kat with isocyanate 1, reported in x parts of isocyanate per 100 parts of polyol component. Tensile strength (TS) and elongation were determined in accordance with DIN 53504.

| | E1 | E2 | IE 1 | IE 2 | E3 | E4 | IE 3 | IE 4 |
|---|---|---|---|---|---|---|---|---|
| Polyol 1 | 98.210 | 81.985 | 60.000 | 50.000 | | | | |
| Polyol 2 | | | | | 98.240 | 83.230 | 60.000 | 49.100 |
| KV 1 | | 15.000 | | | | 15.000 | | |
| KV 2 | | | 38.230 | 48.230 | | | 38.200 | 49.100 |
| Defoam | 0.500 | 0.500 | 0.500 | 0.500 | 0.500 | 0.500 | 0.500 | 0.500 |
| Z1 | | 2.500 | | | | | | |
| Z2 | 1.250 | | 1.250 | 1.250 | 1.250 | 1.250 | 1.250 | 1.250 |
| Kat 1 | 0.040 | 0.015 | 0.02 | 0.02 | 0.01 | 0.02 | 0.050 | 0.050 |
| ISO 1 | 100 | 100 | 100 | 100 | 100 | 100 | 100 | 100 |
| MV 100: | 36.3 | 94.4 | 58.5 | 64.3 | 37.8 | 95.7 | 59.4 | 65.6 |
| Mol of KV/g | 0 | 0.86*10⁻³ | 0.60*10⁻³ | 0.73*10⁻³ | 0 | 0.85*10⁻³ | 0.59*10⁻³ | 0.73*10⁻³ |
| of PU | | | | | | | | |
| Hardness | 68 A | 82 A | 76 A | 85 A | 59 A | 59 D | 60 D | 69 D |
| [Shore A or D] | | | | | | | | |
| TS [MPa] | 4.2 | 15.1 | 12.6 | 25.8 | 5.8 | 11.3 | 15.9 | 31.7 |
| Elongation [%] | 109 | 107 | 148 | 142 | 145 | 28 | 46 | 28 |

As can be seen from the examples, small molar amounts of the inventive chain extender in combination with polyfunctional aliphatic isocyanates lead to better mechanical properties (higher TS and better elongation) at comparable hardnesses.

1. A process for producing a polyurethane-coated conduit element, process comprising:
mixing an aliphatic polyisocyanate with
a compound having at least two hydrogen atoms which are reactive toward isocyanate,
catalyst and
optionally an auxiliary, an additive or both, thereby forming a reaction mixture, and
applying the reaction mixture to a conduit element and reacting the reacting mixture, thereby forming a polyurethane layer,
wherein the compound is based on an alkoxylation product of an aromatic starter molecule.

2. A process for producing a polyurethane-coated conduit element, the process comprising:
mixing an aliphatic polyisocyanate with
a compound having at least two hydrogen atoms which are reactive toward isocyanate,
catalyst and
optionally an auxiliary, an additive or both, thereby forming a reaction mixture,
introducing the reaction mixture into a mold
curing to form a molding,
removing the molding from the mold, and
applying a removed mold to a conduit element,
wherein the compound is at least one compound based on an alkoxylation product of an aromatic starter molecule.

3. The process according to claim 1,
wherein the aromatic starter molecule comprises at least two benzene rings.

4. The process according to claim 1,
wherein the aromatic starter is a bisphenol or a derivative of a bisphenol.

5. The process according to claim 1,
wherein the aromatic starter is bisphenol A or bisphenol S.

6. The process according to claim 1,
wherein the compound has a hydroxyl number of from 100 to 400 mg KOH/g.

7. The process according to claim 1,
wherein the aliphatic isocyanate comprises aliphatic isocyanurate, allophanate, or biuret.

8. The process according to claim 7,
wherein the aliphatic isocyanurate is an isocyanurate derived from hexamethylene diisocyanate.

9. A polyurethane-coated conduit element obtained by the process according to claim 1.

10. The polyurethane-coated conduit element according to claim 9,
wherein the polyurethane-coated conduit element is a pipe of an off-shore pipeline, a field joint of an off-shore pipeline, or an eruption cross of an off-shore pipeline.

11. The process according to claim 2,
wherein the aromatic starter molecule comprises at least two benzene rings.

12. The process according to claim 2,
wherein the aromatic starter is a bisphenol or a derivative of a bisphenol.

13. The process according to claim 2,
wherein the aromatic starter is bisphenol A or bisphenol S.

14. The process according to claim 2,
wherein the compound has a hydroxyl number of from 100 to 400 mg KOH/g.

15. The process according to claim 2,
wherein the aliphatic isocyanate comprises aliphatic isocyanurate, allophanate, or biuret.

16. The process according to claim 15,
wherein the aliphatic isocyanurate is an isocyanurate derived from hexamethylene diisocyanate.

17. A polyurethane-coated conduit element obtained by the process according to claim 2.

18. The polyurethane-coated conduit element according to claim 17,
wherein the polyurethane-coated conduit element is a pipe of an off-shore pipeline, a field joint of an off-shore pipeline or an eruption cross of an off-shore pipeline.
